(19) United States
(12) Patent Application Publication
(10) Pub. No.: US 2013/0329767 A1
(43) Pub. Date: Dec. 12, 2013

(54) CARGO MONITORING SENSOR WITH HANDLE

(71) Applicant: Watlow Electric Manufacturing Company, St. Louis, MO (US)

(72) Inventors: George Jambor, Richmond, IL (US); Scott Stilin, Richmond, IL (US); Ryan Affara, Richmond, IL (US); Arthur Volbrecht, Richmond, IL (US); Michael Karpa, Richmond, IL (US)

(73) Assignee: Watlow Electric Manufacturing Company, St. Louis, MO (US)

(21) Appl. No.: 13/916,230

(22) Filed: Jun. 12, 2013

Related U.S. Application Data
(60) Provisional application No. 61/658,844, filed on Jun. 12, 2012.

(51) Int. Cl. G01K 7/22

(52) U.S. Cl. CPC G01K 7/22
USPC 374/185

(57) ABSTRACT

A temperature sensor assembly is provided that includes a handle defining an internal cavity, and a probe secured to the handle and extending distally therefrom. The probe includes a sheath, a thermistor disposed within the sheath and defining a pair of wires and a bead formed at a distal end portion of the pair of wires. An electrical noise suppression device is disposed within the internal cavity of the handle and is electrically connected to the pair of thermistor wires. A set of lead wires is secured to a proximal end portion of the handle and are electrically connected to the electrical noise suppression device. An adhesive lined heat shrink tubing extends from around the bead of the thermistor, around the pair of thermistor wires, around the electrical noise suppression device, and to around at least a portion of the lead wires.

### CROSS-REFERENCE TO RELATED APPLICATIONS

This application claims the benefit of provisional application Ser. No. 61/658,844, filed on Jun. 12, 2012. The disclosure of the above application is incorporated herein by reference

### FIELD

The present disclosure relates to temperature sensors, and in particular, temperature sensors for use in monitoring the temperature of cargo during transport in mobile applications such as trailers, truck bodies, buses, shipboard containers and railway cars.

### BACKGROUND

The statements in this section merely provide background information related to the present disclosure and may not constitute prior art.

Transportation of cargo that must be maintained at certain temperatures, for example refrigerated goods, is often challenging when traveling long distances and when equipment failures occur. If the refrigeration equipment fails or is not functioning properly, and this goes unnoticed, the entire load of cargo can be lost or compromised. Depending on the cargo, a significant amount of money, often times thousands and even millions of dollars, is lost when the cargo is not maintained at a desired temperature.

Systems exist that can monitor the temperature of a cargo load and store such information in a logger onboard the vehicle, or even transmit information about the temperature during transport wirelessly to a home base. Such systems often include temperature sensors that are relatively bulky, difficult to use and maintain, and have a relatively slow response time.

### SUMMARY

In one form of the present disclosure, a temperature sensor assembly is provided that comprises a handle defining an internal cavity, and a probe secured to the handle and extending distally therefrom. The probe comprises a sheath, a thermistor disposed within the sheath and defining a pair of wires and a bead formed at a distal end portion of the pair of wires. An electrical noise suppression device is disposed within the internal cavity of the handle and is electrically connected to the pair of thermistor wires, the electrical noise suppression device being spaced proximally away from the thermistor bead and outside of the sheath. A set of jacketed lead wires are secured to a proximal end portion of the handle and are electrically connected to the electrical noise suppression device. An electrical connector is secured to an end portion of the set of jacketed lead wires, and an adhesive lined heat shrink tubing extends from around the bead of the thermistor, around the pair of thermistor wires, around the electrical noise suppression device, and to around at least a portion of the jacketed lead wires.

In another form, a temperature sensor assembly is provided that comprises a handle defining an internal cavity, and a probe secured to the handle and extending distally therefrom. The probe comprises a sheath, a thermistor disposed within the sheath and defining a pair of wires, and a bead formed at a distal end portion of the pair of wires. An electrical noise suppression device is disposed within the internal cavity of the handle and is electrically connected to the pair of thermistor wires. A set of lead wires is secured to a proximal end portion of the handle and are electrically connected to the electrical noise suppression device, and an adhesive lined heat shrink tubing extends from around the bead of the thermistor, around the pair of thermistor wires, around the electrical noise suppression device, and to around at least a portion of the lead wires.

Various forms of the temperature sensor assembly are provided by the present disclosure, including but not limited to the use of a capacitor for the noise suppression device, different methods of securing each of the probe, the handle, and the jacketed lead wires to each other, and the use of certain materials for each of the components and subcomponents of the assembly. It should also be understood that the teachings of the present disclosure may also be applied to other sensor types and are not limited to temperature sensors per se. For example, the teachings of the present disclosure may be applied to liquid level sensors, pressure sensors, or particulate sensors, among others.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a temperature sensor assembly constructed in accordance with the principles of the present disclosure;

FIG. 2 is an exploded perspective view of the temperature sensor assembly in accordance with the principles of the present disclosure;

FIG. 3 is a perspective view of a handle and a probe of the temperature sensor assembly in accordance with the principles of the present disclosure;

FIG. 4 is a cross-sectional view, taken along line 4-4 of FIG. 3, in accordance with the principles of the present disclosure;

FIG. 5 is an enlarged cross-sectional view, in detail 5-5 of FIG. 4, in accordance with the principles of the present disclosure; and

FIG. 6 is a top view of the temperature sensor assembly showing the flexible jacketed lead wires and constructed in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

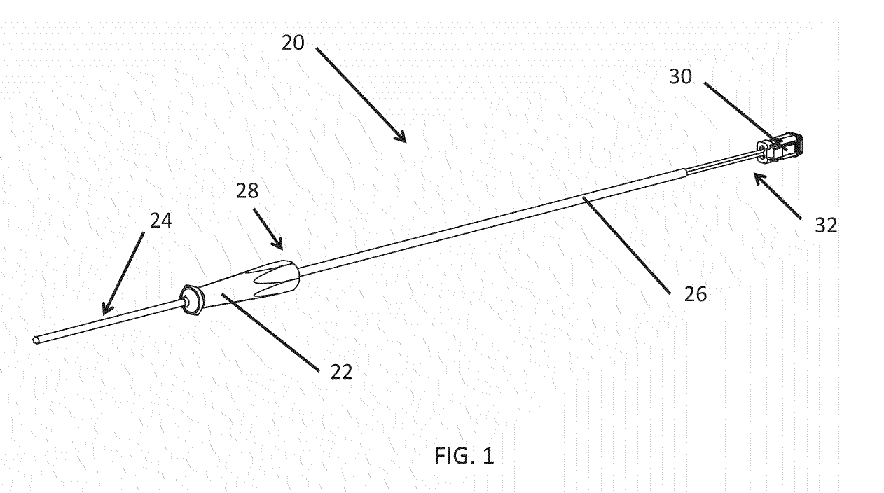

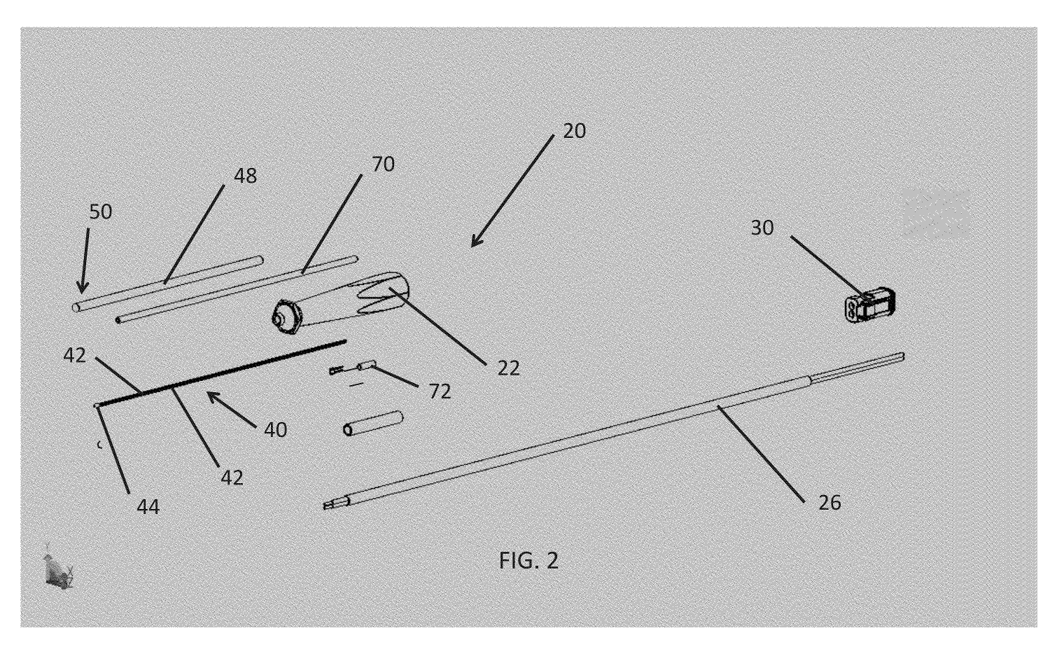

Referring to FIGS. 1 and 2, a temperature sensor assembly according to one form of the present disclosure is illustrated and generally indicated by reference numeral 20. The temperature sensor assembly 20 comprises a handle 22 and a probe 24, which is secured to the handle 22 and extends distally therefrom as shown. A set of jacketed lead wires 26 are secured to a proximal end portion 28 of the handle 22, and an electrical connector 30 is secured to an end portion 32 of the set of jacketed lead wires 26. Accordingly, the temperature sensor assembly 20 can be connected to a data storage device such as a logger (not shown), or other computer device in order to transfer and store temperature information.

The temperature sensor in one form is a thermistor 40, which includes a pair of wires 42 and a bead 44 formed at a distal end portion 46 of the pair of wires 42. The thermistor 40 is disposed within a sheath 48 of the probe as shown, wherein the bead 44 is located near a distal end 50 of the probe 24 so that it is near a location at which a temperature is desired. It should be understood that other forms of temperature sensors such as thermocouples and RTDs (Resistance Temperature Detectors) may also be employed within the structure of the present disclosure, along with other types of sensors such as pressure sensors, particulate sensors, or liquid level sensors, by way of example. Accordingly, the present disclosure is not intended to be limited to temperature sensing or temperature sensing with a thermistor.

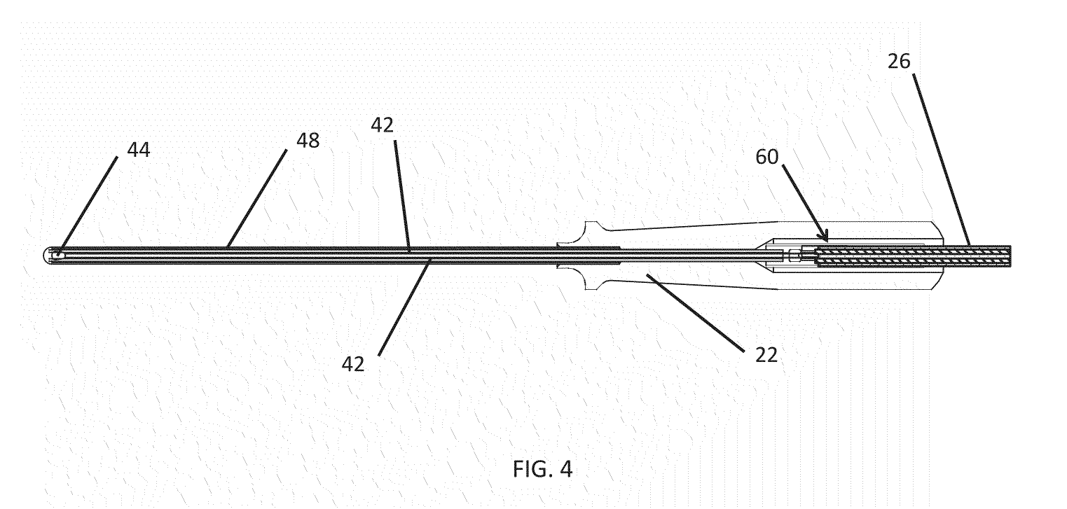

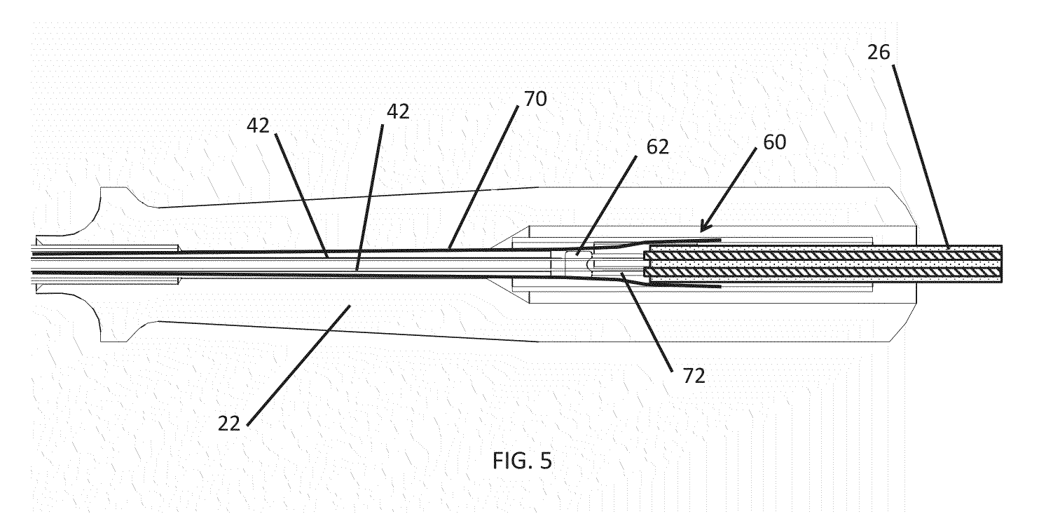

Referring now to FIGS. 4 and 5, the handle 22 defines an internal cavity 60, in which an electrical noise suppression device 62 is disposed. In this form, the electrical noise suppression device 62 is a capacitor, however, it should be understood that other types of electrical noise suppression devices and/or circuits may be employed while remaining within the scope of the present disclosure. The electrical noise suppression device 62 is electrically connected to the pair of thermistor wires 42, and is advantageously spaced proximally away from the thermistor bead 44 and outside the sheath 48. Because the thermistor bead 44 is spaced a distance from the electrical noise suppression device 62, the size of the sheath 48 is reduced, and the response time of the temperature sensor assembly 20 is reduced, thus improving its overall performance.

As further shown, the set of jacketed lead wires 26 are electrically connected to the electrical noise suppression device 62 within the handle 22. And with reference to FIGS. 2, 4 and 5, an adhesive lined heat shrink tubing 70 surrounds the thermistor 40, the electrical noise suppression device 62, and at least a portion of the jacketed lead wires 26. More specifically, the adhesive lined heat shrink tubing 70 extends from around the bead 44 of the thermistor 40, around the pair of thermistor wires 42, around the electrical noise suppression device 62, and to around at least a portion of the jacketed lead wires 26. Advantageously, this adhesive lined heat shrink tubing 70 provides a moisture seal for the overall assembly in which it encases, and reduces the possibility of moisture intrusion that is more likely with other mechanical or material sealing approaches such as sleeves that merely cover the electrical connection between components or a potting compound. The adhesive lined heat shrink tubing 70 also provides a certain degree of mechanical protection for the electrical noise suppression device 62 against shock and vibration.

As further shown, the electrical noise suppression device 62 in one form is crimped to the thermistor wires 42 and the jacketed lead wires 26 using a metal band 72. In another form, the electrical noise suppression device 62 is soldered or welded to the thermistor wires 42 and the jacketed lead wires 26. In another form, the electrical noise suppression device 62 is insert molded into the handle cavity 60. It should be understood that these connection and attachment methods are merely exemplary and that other types of connections and attachments may be employed while remaining within the scope of the present disclosure.

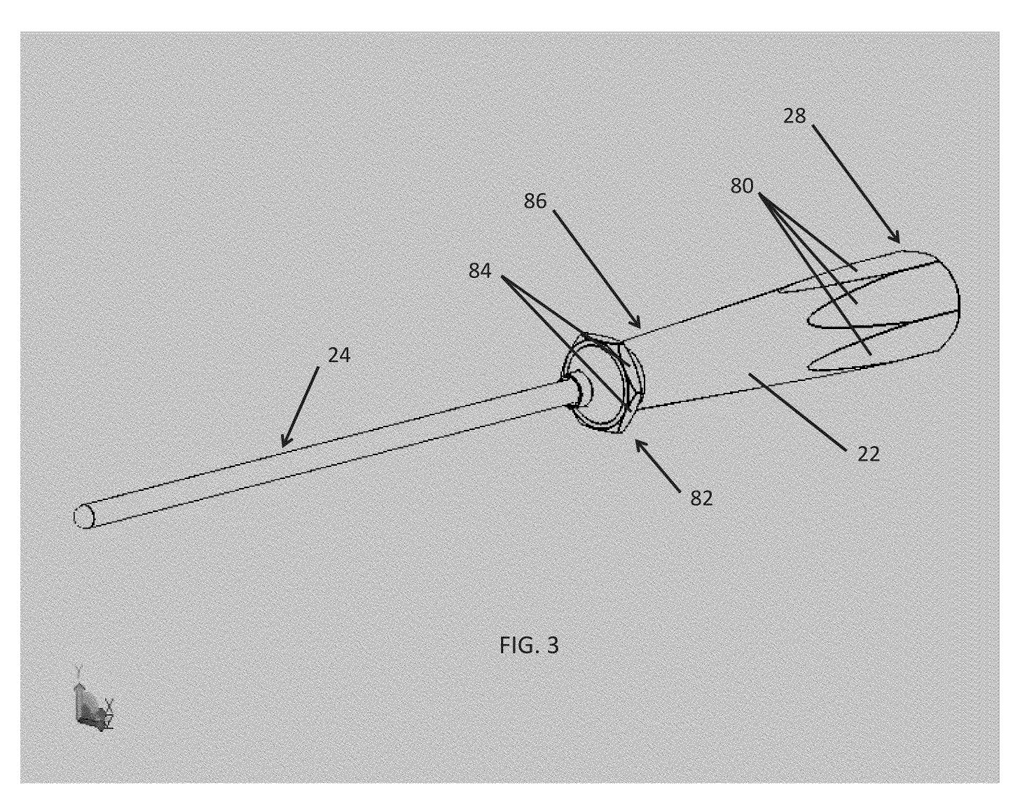

Referring now to FIG. 3, the handle 22 defines a plurality of flats 80 disposed around its periphery as shown. These flats 80 provide a feature to aid in placement of the temperature sensor assembly 20 and also prevent the handle 22 from rolling away while an operator is securing probe 24. The flats 80 also provide an increased surface area for bonding of securing tape that is sometimes used to hold the probe 24 in place during operation. (Traditional round handles provide only line contact, and thus their contact surface area is limited). Additionally, the geometry of the handle 22 provides for ease of handling, especially when operators are wearing bulky gloves. It should be understood that greater or fewer than the six (6) flats 80 as shown may be employed while remaining within the scope of the present disclosure.

The handle 22 also includes a distal flange 82 having a plurality of flats 84 disposed around a periphery of the flange 82, which are aligned with the flats 80 on the handle 22. These flats 84 also provide similar functionality as the flats 80, and the distal flange 82 also provides for improved handling by an operator. The handle 22 further tapers inwardly as shown from its proximal end portion 28 to a distal end portion 86 for still further improvements in handling and use.

At the interfaces between various components of the temperature sensor assembly 20, different approaches may be employed to secure the components to each other. In one form, the thermistor wires 42 are secured to the sheath 48 and the noise suppression device 62 to the handle cavity 60 using an epoxy material that conforms to Title 21, U.S. Code of Federal Regulations, FDA Chapter 1, Section 175.105 requirements for food safety.

In one form of the present disclosure, the sheath 48 is secured to the handle 22 by brazing or welding. When brazing is employed, a silver material is used due to its lower melting temperature, compatibility with the FDA regulations as set forth above, and its ability to be brazed to relatively thin walled objects, such as the sheath 48 in this application. The jacketed lead wires 26 are secured to the handle 22 by a potting compound that conforms to Title 21, U.S. Code of Federal Regulations, FDA Chapter 1, Section 175.105 requirements for food safety. In a variation of this form of the present disclosure, a rigid tube (not shown), for example stainless steel, surrounds the jacketed lead wires 26 and is crimped or deformed into the potting compound.

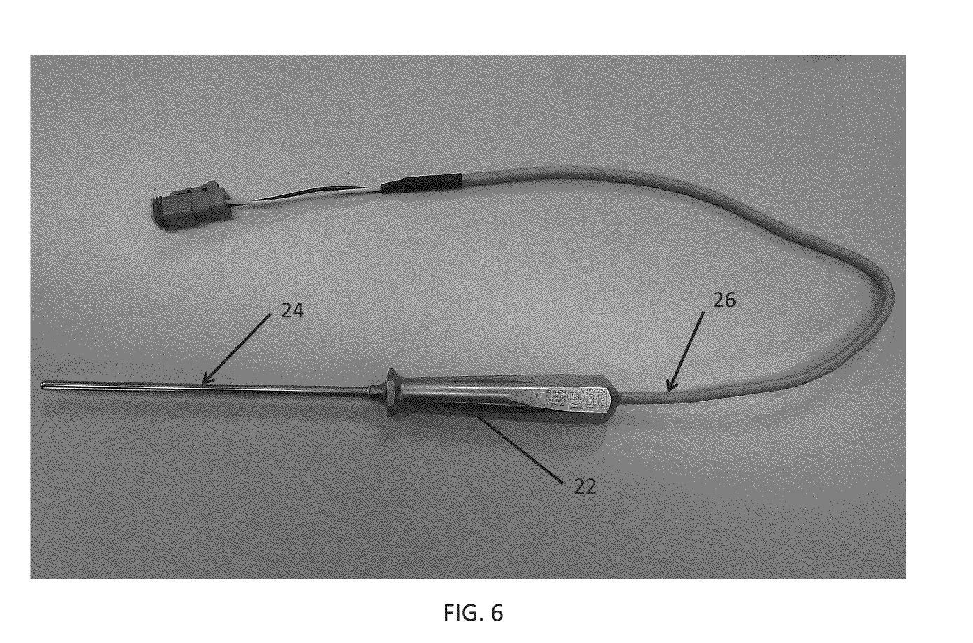

In another form of the present disclosure, the set of jacketed lead wires 26 are pressure extruded in order to prevent the wires from collapsing when they are bent away from the encapsulating epoxy. (This configuration/position of the jacketed lead wires 26 is illustrated in FIG. 6). Additionally, the pressure extruded form reduces the possibility of air gaps between the internal wires and the encapsulating epoxy of the jacketed lead wires 26, thus improving performance and durability, and also providing compliance with food safety requirements as set forth above.

In one form of the present disclosure, both the sheath 48 and the handle 22 are a stainless steel material in order to conform with the FDA regulations as set forth above. It should be understood, however, that other materials may be used while remaining within the scope of the present disclosure. For example, the handle 22 may be a plastic material, such as a thermoset or a thermoplastic, while the sheath 48 remains a stainless steel. Additionally, an aluminum alloy may be used as the material for either or both of the sheath 48 and the handle 22.

Because of the compact design and configuration of components of the temperature sensor assembly 20, no heat transfer compound is used within the sheath 48, which reduces the cost and complexity of the design. It should be understood, however, that a heat transfer compound may be used while still remaining within the scope of the present disclosure.

In operation, one application of the temperature sensor assembly 20 is for monitoring the temperature of cargo during transport in mobile applications such as trailers, truck bodies, buses, shipboard containers and railway cars. It should be understood, however, that the temperature sensor assembly 20 may be employed in other applications while remaining within the scope of the present disclosure.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A temperature sensor assembly comprising:
a handle defining an internal cavity;
a probe secured to the handle and extending distally therefrom, the probe comprising:
a sheath;
a thermistor disposed within the sheath and defining a pair of wires and a bead formed at a distal end portion of the pair of wires;
an electrical noise suppression device disposed within the internal cavity of the handle and electrically connected to the pair of thermistor wires, the electrical noise suppression device being spaced proximally away from the thermistor bead and outside of the sheath;
a set of jacketed lead wires secured to a proximal end portion of the handle and electrically connected to the electrical noise suppression device;
an electrical connector secured to an end portion of the set of jacketed lead wires; and
an adhesive lined heat shrink tubing extending from around the bead of the thermistor, around the pair of thermistor wires, around the electrical noise suppression device, and to around at least a portion of the jacketed lead wires.

2. The temperature sensor assembly according to claim 1, wherein the electrical noise suppression device is a capacitor.

3. The temperature sensor assembly according to claim 2, wherein the capacitor is crimped to the thermistor wires and the jacketed lead wires using a metal band.

4. The temperature sensor assembly according to claim 2, wherein the capacitor is soldered or welded to the thermistor wires and the jacketed lead wires.

5. The temperature sensor assembly according to claim 1, wherein the handle defines a plurality of flats disposed around a periphery of the handle.

6. The temperature sensor assembly according to claim 5, wherein the handle further defines a distal flange having a plurality of flats disposed around a periphery of the flange.

7. The temperature sensor assembly according to claim 1, wherein the handle tapers inwardly from a proximal end portion to a distal end portion.

8. The temperature sensor assembly according to claim 1, wherein the thermistor wires are secured to the sheath and the noise suppression device to the handle cavity using an epoxy material that conforms to Title 21, U.S. Code of Federal Regulations, FDA Chapter 1, Section 175.105 requirements for food safety.

9. The temperature sensor assembly according to claim 1, wherein the electrical noise suppression device is insert molded into the handle cavity.

10. The temperature sensor assembly according to claim 1, wherein the sheath is secured to the handle by at least one of brazing and welding.

11. The temperature sensor assembly according to claim 10, wherein a silver material is used for the brazing.

12. The temperature sensor assembly according to claim 1, wherein the jacketed lead wires are secured to the handle by a potting compound that conforms to Title 21, U.S. Code of Federal Regulations, FDA Chapter 1, Section 175.105 requirements for food safety.

13. The temperature sensor assembly according to claim 12 further comprising a rigid tube surrounding the jacketed lead wires that is deformed into the potting compound.

14. The temperature sensor assembly according to claim 1, wherein the set of jacketed lead wires are pressure extruded.

15. The temperature sensor assembly according to claim 1, wherein the sheath and the handle are a stainless steel material.

16. The temperature sensor assembly according to claim 1, wherein no heat transfer compound is used within the sheath.

17. A temperature sensor assembly comprising:
a handle defining an internal cavity;
a probe secured to the handle and extending distally therefrom, the probe comprising:
a sheath;
a thermistor disposed within the sheath and defining a pair of wires and a bead formed at a distal end portion of the pair of wires;
an electrical noise suppression device disposed within the internal cavity of the handle and electrically connected to the pair of thermistor wires;
a set of lead wires secured to a proximal end portion of the handle and electrically connected to the electrical noise suppression device; and
an adhesive lined heat shrink tubing extending from around the bead of the thermistor, around the pair of thermistor wires, around the electrical noise suppression device, and to around at least a portion of the lead wires.
